(19) United States
(12) Patent Application Publication
(10) Pub. No.: US 2026/0276498 A1
(43) Pub. Date: Sep. 17, 2026

(54) CRYO-EM SPECIMEN PREPARATION

(71) Applicant: THE JOHNS HOPKINS UNIVERSITY, Baltimore, MD (US)

(72) Inventors: Edward TWOMEY, Baltimore, MD (US); Alejandra MONTAÑO ROMERO, Baltimore, MD (US); Calli BONIN, Baltimore, MD (US)

(21) Appl. No.: 19/472,805

(22) PCT Filed: Apr. 9, 2024
(86) PCT No.: PCT/US2024/023668

§ 371 Date: Oct. 6, 2025

Related U.S. Application Data
(60) Provisional application No. 63/495,897, filed on Apr. 13, 2023.

(51) Int. Cl. G01N 1/42; G01N 1/44

(52) U.S. Cl. CPC G01N 1/42; G01N 1/44

(57) ABSTRACT

A system for and method for controlling the timing of photolysis within a specimen prior to vitrification during specimen preparation for cryo-electron microscopy. Embodiments in accordance with the present disclosure include a system and method that control irradiation prior to vitrification, allowing for precise specimen preparation in tr-cryo-EM. Embodiments of the device and method in accordance with the present disclosure enable interrogation of changes in macromolecular structure as a function of time. Such interrogation is used, for example, but not limited to, for pharmaceutical design, and addresses questions such as, for example, but not limited to, how molecules dynamically alter protein conformational landscapes in vitro and in situ.

### CROSS REFERENCE TO RELATED APPLICATIONS

This application is the national stage entry of International Patent Application No. PCT/US2024/023668, filed on Apr. 9, 2024, and published as WO 2024/215636 A8 on Oct. 17, 2024, which claims the benefit of U.S. Provisional Patent Application Ser. No. 63/495,897, filed Apr. 13, 2023, which are hereby incorporated by reference herein in their entireties.

### FIELD

This disclosure relates generally to precise control of the timing of an activator of a specimen prior to vitrification during specimen preparation for cryo-electron microscopy.

### BACKGROUND

Cells house a complex and dynamic community of macromolecules that engage one another through a mix of transient or stable interactions and move between different three-dimensional structural states (conformations) to drive the cellular system away from equilibria and dictate biological function. Conformational change in cells happens when the cell shape and structure are altered because of alteration in the cell environment, for example, but not limited to, pH, temperature, and ionic strength, or the binding of a ligand to a receptor, or the binding of a substrate to an enzyme. A description of conformational changes and structure enables understanding of biology and disease, and aids in the development of therapeutics. Structure determination addresses the problem of relating structural information to biological function.

Cryo-electron microscopy (cryo-EM) and cryo-electron tomography (cryo-ET) are methods for elucidating macromolecular structures. Cryo-EM can probe proteins and offers insight into conformational and energy landscapes. The atomic details of, for example, molecular shapes, conformations, and interactions of a specimen can be obtained. Cryo-EM enables the imaging of molecules frozen in layers of vitreous ice. The images can be used to reconstruct the molecular structure of a molecule in multiple conformations. Cryo-ET enables imaging of vitrified specimens with a transmission-electron microscope (TEM) carried out in situ, providing the molecular details of organelles, proteins, and nucleic acids in their native context at sub-nanometer resolution.

Time-resolved cryo-EM (tr-cryo-EM) enables vitrification of a specimen across timescales to dissect reactions and three-dimensional conformations during biological events. Tr-cryo-EM enables an understanding of how biological processes develop as a function of time. Tr-cryo-EM can involve, for example, microfluidics and/or light coupling. With respect to microfluidics, channel sizes dictate how long solutions mix with each other prior to vitrification, resulting in a controlled temporal resolution. With respect to light coupling, the specimen is irradiated with light prior to freezing. To create a temporal resolution, the specimen is incubated with a caged ligand that is activated upon photolysis during irradiation, or the specimen is engineered to be directly light activated, or the specimen is naturally sensitive to light. Light coupling involves either irradiating the specimen and then freezing the specimen, or plunging the specimen through a fixed light path during the vitrification process.

Specimen preparation for both cryo-EM and cryo-ET involves timescale issues. The timescale of specimen preparation can be slower than the speed at which events occur in human cells, preventing the imaging of short-lived events that are fundamental for biology and drug design. In addition, the timescale of specimen preparation is not readily tunable, impeding an understanding of how biological processes develop as a function of time. Both issues are related to specimen preparation on non-physiological timescales. What is needed is a device that that prepares time-resolved cryo-EM/ET specimens across an adjustable temporal spectrum. Such a device could be used to study the mechanistic, atomic details of molecules as a function of time and at a desired resolution, such as, for example, but not limited to, one millisecond, to aid discovery in both biology and drug design.

### SUMMARY

Embodiments in accordance with the present disclosure provide a means for time-resolved cryo-EM specimen preparation. Embodiments in accordance with the present disclosure include a system and method that control irradiation prior to vitrification, allowing for precise specimen preparation in tr-cryo-EM. Embodiments of the device and method in accordance with the present disclosure enable interrogation of changes in macromolecular structure as a function of time. Such interrogation is used, for example, but not limited to, for pharmaceutical design, and addresses questions such as, for example, but not limited to, how molecules dynamically alter protein conformational landscapes in vitro and in situ.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for preparing a sample for time-resolved cryo-electron microscopy. The method includes receiving a specimen, receiving configuration data, and applying the specimen to a specimen receiver. The method also includes computing, based on the configuration data, an activation time, moving the specimen receiver towards a vitrification medium, exposing the specimen on the specimen receiver to an activating agent at the activation time, and preparing the sample by vitrifying the activated specimen. Other embodiments of this aspect include corresponding computer systems, apparatus, and computer programs recorded on one or more computer storage devices, each configured to perform the actions of the methods.

Implementations may include one or more of the following features. The method as may include removing excess of the specimen from the specimen receiver. The configuration data may include an application-dependent desired temporal resolution and a configuration-dependent time difference between when the specimen receiver begins moving towards the vitrification medium and when the specimen enters the vitrification medium. The activation time may include a difference between the application-dependent desired temporal resolution and the configuration-dependent time difference. The method may include incubating the specimen with a ligand. The ligand may include an inactive, chemically caged ligand. The method may include focusing the activating agent to a focal point in a path of the specimen receiver. Implementations of the described techniques may include hardware, a method or process, or computer software on a computer-accessible medium.

One general aspect includes a system for preparing a sample for cryo-electron microscopy. The system includes a specimen delivery device configured to access a specimen and apply the specimen to a specimen receiver. The system is configured to generate a first signal when the specimen is applied to the specimen receiver. The system includes a plunging device configured to move the specimen receiver into a cryogen. The plunging device is configured to generate a second signal when the specimen is moved. The system includes an activation device configured to activate the specimen. The activation device is configured to release an activating agent after a time delay, and the specimen is activated by the activating agent. The system also includes a vitrification device configured to receive the specimen receiver and vitrify the activated specimen in a vitrification medium. The system includes a controller configured to execute instructions that perform operations including accessing configuration data including a desired temporal resolution, and a configuration-dependent time difference between when the specimen receiver begins moving towards the vitrification medium and when the specimen enters the vitrification medium. The operations include computing the time delay based at least upon the desired temporal resolution and the configuration-dependent time difference, receiving the first signal, activating the plunging device based on the first signal, receiving the second signal when the plunging device is activated, activating the activation device based at least on the time delay and the second signal, and deactivating the plunging device based at least on the second signal. Other embodiments of this aspect include corresponding computer systems, apparatus, and computer programs recorded on one or more computer storage devices, each configured to perform the actions of the methods.

Implementations may include one or more of the following features. The specimen receiver may include a cryogrid. The activating agent may include an electromagnetic signal, an optical signal, and/or a thermal sensation. The system as may include a specimen incubator configured to incubate the specimen with a ligand. The ligand may include an inactive, chemically caged ligand. The system may include a blotter device configured to remove excess of the specimen from the specimen receiver. The blotter device may include a blotter, a solenoid configured to activate and deactivate the blotter, and a communications port configured to send a third signal to the controller when the blotter is deactivated. The plunging device may include a plunger, a solenoid configured to activate the plunger, a communications port configured to send the second signal to the controller when the plunging device is activated, and a coupler configured to couple the plunging device with the specimen receiver. The system may include a sensor configured to collect information about the system. The operations may include focusing the activating agent to a focal point in a path of the specimen receiver. The specimen receiver may include a cryogrid. Implementations of the described techniques may include hardware, a method or process, or computer software on a computer-accessible medium.

### DRAWINGS

The above and/or other aspects and advantages will become more apparent and more readily appreciated from the following detailed description of examples, taken in conjunction with the accompanying drawings, in which:

FIG. 1 is a schematic block diagram of an exemplary system in accordance with embodiments of the present disclosure;

FIGS. 2A and 2B are flowcharts of exemplary processes in accordance with embodiments of the present disclosure;

FIGS. 3A and 3B are pictorial representations of an exemplary embodiment in accordance with the present disclosure;

FIG. 3C is a flowchart of an exemplary activation scenario in accordance with the present disclosure;

FIG. 3D is a pictorial illustration of an exemplary activation scenario in accordance with the present disclosure;

FIG. 4 is a pictorial representation of the relationship of the light source, the focal point, and the cryogen container in accordance with embodiments of the present disclosure;

FIGS. 5A and 5B are exemplary schematic diagrams of systems in accordance with embodiments of the present disclosure;

FIGS. 5C and 5D are flowcharts of exemplary slow and fast processes in accordance with embodiments of the present disclosure;

FIGS. 6A-6C are schematic diagrams of exemplary mounting devices in accordance with embodiments of the present disclosure;

FIG. 7A is a pictorial illustration of a lens configuration for focusing an exemplary light beam in accordance with embodiments of the present disclosure;

FIG. 7B is a schematic diagram of an exemplary cryogrid descending into a vitrification bath in accordance with embodiments of the present disclosure;

FIG. 7C is a pair of irradiance graphs, one for a copper grid, one for a gold grid, that show irradiance of a light source at 100%;

FIG. 7D is a user interface diagram of an exemplary user interface in accordance with embodiments of the present disclosure; and

FIG. 8 is a flowchart of a method for preparing a sample in accordance with embodiments of the present disclosure.

### DETAILED DESCRIPTION

Embodiments as described herein are described in sufficient detail to enable those skilled in the art to practice the described disclosure and it is to be understood that other embodiments may be utilized and that changes may be made without departing from the scope of the disclosure. The present description is, therefore, merely exemplary.

In embodiments in accordance with the present disclosure, a specimen preparation system is used to study the details of molecules using cryo-EM/cryo-ET as a function of time at a pre-selected temporal resolution. The choice of temporal resolution depends on, for example, but not limited to, the specimen, the environment of the specimen, and the desired use of the processed specimen. The desired temporal resolution is achieved by controlling the time between when the specimen is irradiated and when the specimen is exposed to a cryogen. The specimen preparation system aids research in, for example, but not limited to, biology and drug design, at physiologically relevant time scales in a pre-selected range. The pre-selected range can include, but is not limited to including, a 1 ms-30 second temporal resolution. The specimen preparation system can capture the short-lived, critical states that dictate biological functions. Using caged ligands, biological events such as excitatory/inhibitory neurotransmission, addiction, motivation, muscle contraction, and nucleotide/pH/calcium-dependent processes can be studied using the system and method of the present disclosure. The system and method in accordance with the present disclosure can be applied to cryo-ET to understand molecules in situ. For example, iGluRs in situ can be compared to in vitro specimens from the system and method in accordance with the present disclosure. Further, the system and method in accordance with the present disclosure can be used to understand excitatory neurotransmission through Ionotropic glutamate receptors (iGluRs), which are fundamental for learning and memory, and key targets for treating many neurological disorders.

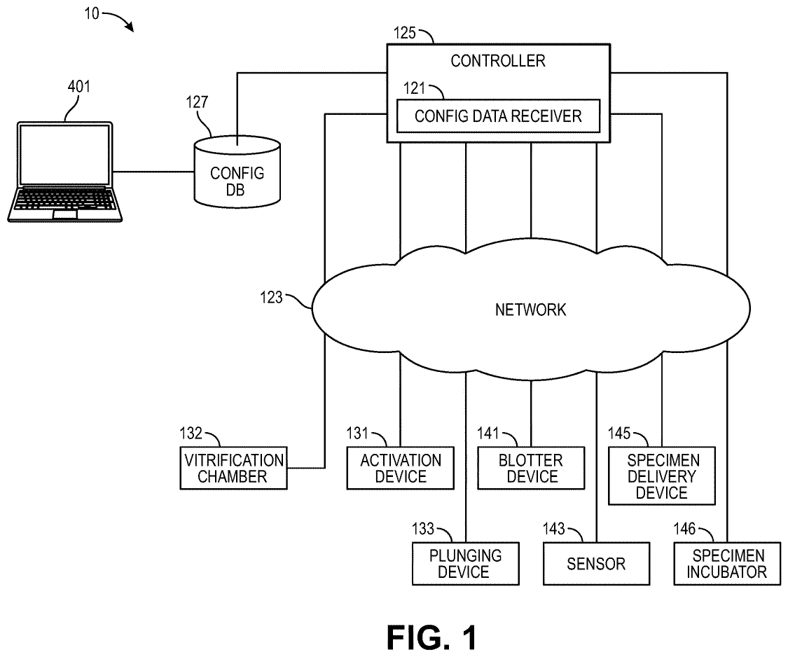

Referring now to FIG. 1, embodiments of the system for specimen preparation in accordance with the present disclosure include, but are not limited to including, components such as a controller, a configuration data receiving device, a specimen receiver, a blotter device, a plunging device, an activation device, and a sensor.

Continuing to refer to FIG. 1, the controller 125 synchronizes behavior among the other components to achieve the desired prepared sample. The controller 125 includes, but is not limited to including, a processor, a configuration data receiver 121 that receives configuration data, a power source to supply power to the controller, and a communications port to enable communications with the other components of the system. In an aspect, the controller 125 is a programmable computer executing instructions to control the components. In an aspect, the controller 125 is, for example, a RASPBERRY-PI® control board. The controller 125 enables specimen preparation across a tunable period by controlling delays that are integrated into LED power as described herein. This approach allows the LED power delay to be tunable so that “ultrafast” (1-15 ms) timescales, “slower” (≥100 ms) timescales, or any timescales in between can be achieved.

Continuing to refer to FIG. 1, the configuration data receiver 121 receives data from a user entry device 401 and/or from a configuration database 127. In an aspect, the user entry device 401 is a laptop, a handheld device, a desktop device, or a tablet. In an aspect, the configuration database 127 is local to the configuration data receiver 121 and/or is a networked database. In some configurations, configuration data 127 are, for example, accessed from a configuration database 127, or are entered by a user at a user entry device 401. Either or both of the configuration database 127 and the user entry device 401 can be communicatively coupled with the controller 125 through a direct link or through network 123, or any other suitable communications option. The configuration data 127 provide the parameters that the controller 125 needs to establish the sample preparation process. In an aspect, a user can enter a desired result, and/or options such as specimen type, specimen environment, ligand, cryogen, and activation device type. The configuration data receiver 121 validates the received data, no matter how the data arrive, and provides the data to the controller 125. Validation involves, for example, ensuring consistency among the entered data, range checking, and component compatibility. The controller 125 uses these parameters to establish the temporal aspects of the specimen preparation, for example, the speed of the plunger 133, the variable aspects of the blotter device 141, variables associated with the activation device 131, and the frame rate of the sensor 143, for example. In an aspect, the desired specimen preparation result is entered, and configuration data 127 associated with the desired result are accessed by the controller 125. In an aspect, the controller 125 accesses default values for the necessary parameters and executes sample preparation autonomously. In an aspect, the controller 125 either recognizes that certain processing prerequisites have been met and takes over, or performs all or most of the processing automatically.

Continuing to refer to FIG. 1, the specimen delivery device 145 accesses the specimen through, for example, manual means. In an aspect, the specimen delivery device is a cryogrid. In an aspect, the specimen delivery device 145 includes mechanical components that access the specimen.

Continuing to refer to FIG. 1, the specimen incubator 146, when used, combines the specimen with, for example, a caged ligand that can undergo photolysis when exposed to light. In an aspect, the specimen incubator 146 includes an incubator device. For some specimens and ligands, the incubation time and other incubation variables are provided by, for example, a look-up table. In an aspect, commercially available ligands are used such as, for example, but not limited to, glutamate (excitatory neurotransmission), Gamma-aminobutyric acid (GABA) (inhibitory neurotransmission), dopamine (addiction, motivation), nicotine (muscle contraction, addiction), Adenosine triphosphate 11 (ATP11) (nucleotide-dependent processes), protons (pH-dependent processes), and calcium (calcium-dependent processes).

Continuing to refer to FIG. 1, whether the specimen is incubated with a ligand or not, the specimen delivery device 145 applies the specimen or incubated specimen to a cryogrid. In an aspect, commercially-available systems are used to apply the specimen to the cryogrid automatically. For example, a specimen delivery device controlled by the controller 125, can deliver the specimen directly to the cryogrid. In an aspect, cells of the specimen are grown on the cryogrid. The amount of specimen applied to or grown on the cryogrid depends upon the desired application. In an aspect, the populated cryogrid consists of particles that are distributed in various orientations or views throughout the holes of the support film of the cryogrid. For some applications, a 3 μl layer of specimen is applied to the cryogrid. The material selected for the cryogrid depends upon the application. In an aspect, the cryogrid is 3 mm in diameter, but can be any size. In an aspect, the cryogrid is circular, but can be any shape. In an aspect, the cryogrid is a metal mesh, for example, but not limited to, a carbon mixture, gold and carbon mixed, and copper and carbon mixed. In an aspect, the specimen on the cryogrid is inspected for its adherence to criteria that make the desired result more likely, for example, but not limited to, if the specimen includes monodisperse particles.

Continuing to refer to FIG. 1, the blotter device 141 removes excess specimen from the cryogrid. In an aspect, the blotter device 141 includes, but is not limited to including, a blotter, a solenoid to activate the blotter, a power source to supply power to the solenoid, and a communications port to enable communications with the controller 125. In an aspect, the excess specimen is removed by the blotter, which can include blotting paper. In an aspect, signals from the controller 125 activate a solenoid that moves the blotter across the specimen on the cryogrid. The controller 125 controls the amount of time the blotter device 141 is removing specimen from the cryogrid. In an aspect, the thickness of ice that develops on the cryogrid after vitrification is a function of the amount of time that the blotter device 141 is removing specimen from the cryogrid.

Continuing to refer to FIG. 1, the plunging device 133, under direction from the controller 125, moves the cryogrid into the cryogen. In an aspect, the plunging device 133 includes, but is not limited to including, a plunger, a solenoid to activate the plunger, a power source to supply power to the solenoid, a communications port to enable communications with the controller 125, and a coupling means to enable coupling the cryogrid with the plunger. In an aspect, the plunging device 133 is communicatively coupled with the controller 125, either through a direct communications channel, or through a communications network 123. In an aspect, the plunger is activated by a solenoid when a signal from the controller 125 is received by the plunging device 133. Other forms of activating the plunger are contemplated by the present disclosure. In an aspect, the plunger is coupled with the cryogrid by a coupling means. In an aspect, the coupling means includes a first end that is coupled with the plunger, and a second end that is coupled with the cryogrid. In an aspect, the first end includes a releasable coupling or a permanent coupling. In an aspect, the permanent coupling is enabled by molding the coupling device with the plunger. In an aspect, the permanent coupling is enabled by adhesive or non-removable fasteners. In an aspect, the releasable coupling is enabled by, for example, but not limited to, releasable adhesives, fasteners, and/or hook-and-eye strips. In an aspect, the second end is permanently or releasably coupled with the cryogrid. In an aspect, the releasable coupling is enabled by, for example, but not limited to, tweezers, fasteners, releasable adhesives, and/or hook-and-eye strips. Other coupling means are contemplated by the present disclosure.

Continuing to refer to FIG. 1, the activation device 131 activates either a ligand incubated with the specimen or the specimen itself before vitrification. In an aspect, the activation device 131 includes, but is not limited to including, an activating agent, a power source to activate the activating agent, and a communications port to enable communications with the controller 125. In an aspect, the activating agent includes, but is not limited to including, a light source. In an aspect, the light source includes an LED or a laser of any wavelength, and/or any compatible model. In an aspect, the activating agent activates the ligand, if present, and/or specimen by exposing the cryogrid to a pre-selected wavelength of light. The pre-selected wavelength is chosen based upon, for example, but not limited to, the ligand and/or the specimen and the application (for example, the biological process) for which the specimen is being prepared. For example, a wavelength of 365 nm is compatible with the use of several commercially-available ligands, while a wavelength of 475 nm is used for optogenetics. Discreet wavelengths are used for a variety of situations, depending upon the desired result. Various types of activating agents are used for a variety of situations, depending upon the desired result. For example, an infrared laser light source is used for thermal sensation.

Continuing to refer to FIG. 1, the interaction between the plunging device 133 and the activation device 131 enables the selection of temporal resolution in embodiments of the system and method in accordance with the present disclosure. Temporal resolution is coupled to the delay in powering the activation source. The controller 125 learns the temporal distance between when the plunging device 133 is activated and when the activating agent generated by the activation device 131. This temporal distance is a function of the configuration of the components of the system and can thus take any value. The controller 125 receives this configured temporal distance from the user, or accesses this value from the configuration database 127, or otherwise determines the value. The desired temporal resolution, when selected by the user or otherwise determined by the controller 125, is used in accordance with the configured temporal distance to determine when to energize the activation device. Specimen thickness can be used to limit temporal resolution under some conditions. For example, a thickness of 15-25 μm, assuming that a 30 μm specimen freezes at 300,000 K s−1, can affect the temporal resolution by, for example, ~0.5 ms.

Continuing to refer to FIG. 1, a vitrification chamber 132 receives the specimen applied to the cryogrid and vitrifies the specimen. In an aspect, the vitrification chamber 132 includes, but is not limited to including, a vitrification container, a cooling agent, and, optionally, a communications port to enable communications with the controller 125. In an aspect, the vitrification container 205 includes a cooling agent compartment and, optionally, a thermal regulation substance 209. In an aspect, the cooling agent is ethane, and nitrogen is stored in the thermal maintenance compartment. In an aspect, the activation device 305 is placed at a distance equal to the radius 403 of the vitrification container. In an aspect, the activating agent 203 crosses the path of the cryogrid 215 at a focal point 715. In an aspect, a lens focusing the activating agent 203 to a focal point 715 is positioned between the activation device 305 and the path between the cryogrid and the vitrification compartment.

Continuing to refer to FIG. 1, the sensor 143 collects information about the movement and status of the plunging device 133 and provides that information to the controller 125. In an aspect, the sensor 143 includes, but is not limited to including, a power source to activate the sensor, and a communications port to enable communications with the controller 125. In an aspect, the sensor is a high frame rate (1,000 fps) camera. The sensor 143 gathers data that are used to recalibrate the system when the components change position relative to each other. In an aspect, the sensor 143 includes a device to capture images.

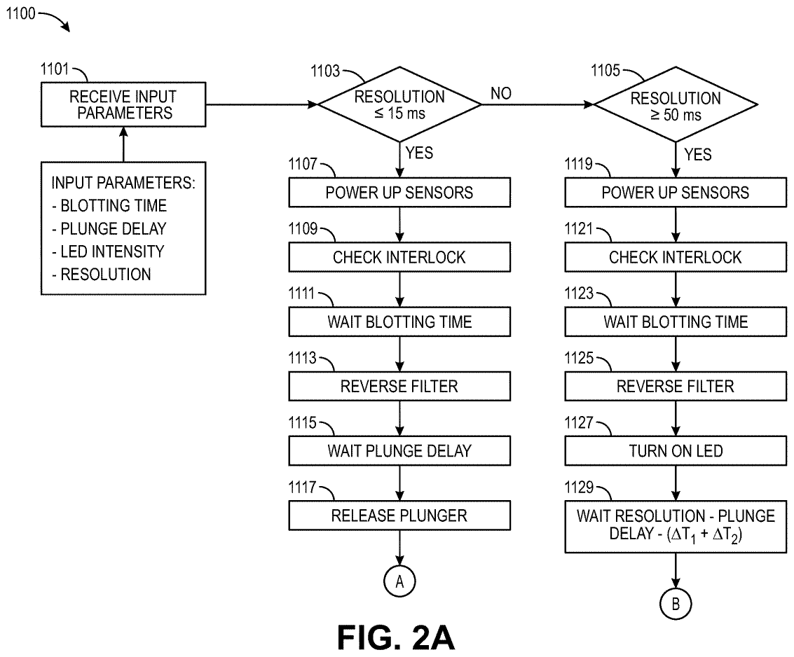

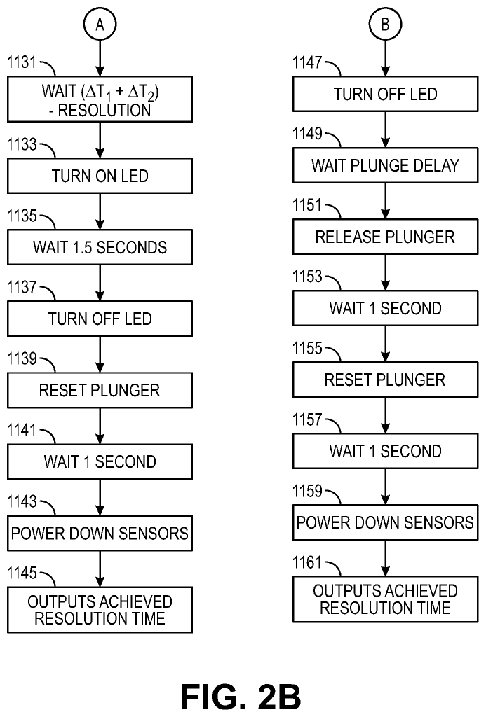

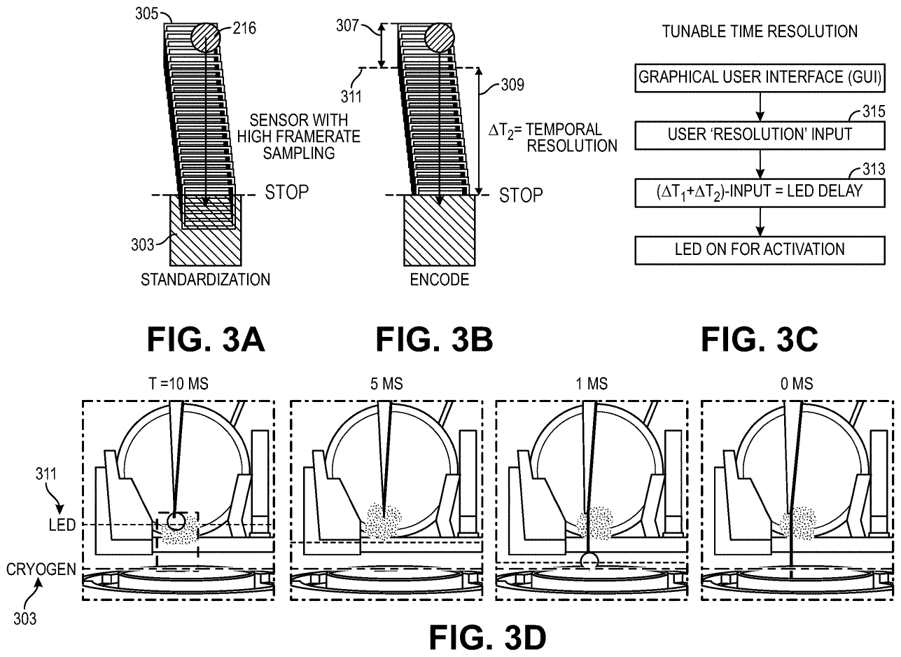

Referring now to FIGS. 2A and 2B, in an exemplary configuration, a method can be executed that chooses an execution path depending upon the selected resolution. In general, if the resolution is ≤15 ms, a “fast” resolution process is executed, whereas if the resolution is ≥100 ms (because it takes 50 ms for the cryogrid to descend into the cryogen from the starting position in an exemplary configuration), a “slow” resolution process is executed. Other timeframes are possible, depending on the configuration. Method 1100 includes, but is not limited to including, receiving 1101 input parameters such as, for example, but not limited to, blotting time, plunge delay, LED intensity, and resolution. If 1103 the selected resolution is ≤15 ms, the method 1100 includes, but is not limited to including, powering 1107 the sensors, checking 1109 for interlock, for example, but not limited to, when a sensor detects that the plunger is blocked, waiting 1111 the selected blotting time, reverse filtering 1113, that is, when the solenoid attached to the filter paper is deactivated and returns to its original position, waiting 1115 a pre-selected plunge delay, for example, but not limited to, between 50 ms and one second inclusive, and releasing 1117 the plunger. Method 1100 includes waiting 1131 the difference between (ΔT₁+ΔT₂) (see FIG. 3B) and the provided resolution, turning on 1133 the LED, waiting 1135 a preselected amount of time, such as, for example, but not limited to, 1.5 seconds, turning off 1137 the LED, resetting 1139 the plunger, that is, the solenoid that is referred to as the plunger is deactivated, waiting 1141 another pre-selected amount of time such as, for example but not limited to one second, powering down 1143 the sensors, and providing 1145 the outputs achieved resolution time, that is the timing of different aspects of the system, including the time resolution of sample preparation.

Continuing to refer to FIGS. 2A and 2B, if 1105 the selected resolution is ≥50 ms, the method 1100 includes, but is not limited to including, powering 1119 the sensors, checking 1121 for interlock, waiting 1123 the selected blotting time, reverse filtering 1125, turning on 1127 the LED, waiting 1129 the difference between (ΔT₁+ΔT₂) (see FIG. 3B), the provided plunge delay, and the provided resolution, turning off 1147 the LED, waiting 1149 a pre-selected plunge delay, and releasing 1151 the plunger. Method 1100 includes waiting 1153 a preselected amount of time, such as, for example, but not limited to, one second, resetting 1155 the plunger, waiting 1157 another pre-selected amount of time such as, for example but not limited to one second, powering down 1159 the sensors, and providing 1161 the outputs achieved resolution time.

Referring now to FIGS. 3A-3D, diagrams illustrating temporal resolution are shown. In FIG. 3A, temporal resolution standardization using a pre-selected frame rate sampling technique considering the amount of time the cryogrid 216 takes to descend into the cryogen 303 from its starting position is shown. The pre-selected frame rate indicates how many frames are captured within a specific time period. For example, using a camera with a frame rate of 960 frames per second, an individual frame is captured every ~1.04 ms. In some configurations, a video is captured using the camera. This process is used to standardize how long the LED delay should be to achieve a precise, reproducible time resolution. In FIG. 3B, encoding of the time resolution defines the descending time as (ΔT1+ΔT2), where ΔT1 307 is the time between the start of plunging and the switching of the LED on 311, and ΔT2 309 is the time from the start of the reaction to vitrification, representing temporal resolution. In FIG. 3C, for tunability of time resolution, an LED delay 313 that is dependent on both user resolution input 315 and (ΔT1 307+ΔT2 309) is shown. LED delay 313 is defined as the difference between (ΔT1 307+ΔT2 309) and the desired resolution 315. In FIG. 3D, shown are images of 10, 5, 1 and 0 ms temporal resolutions.

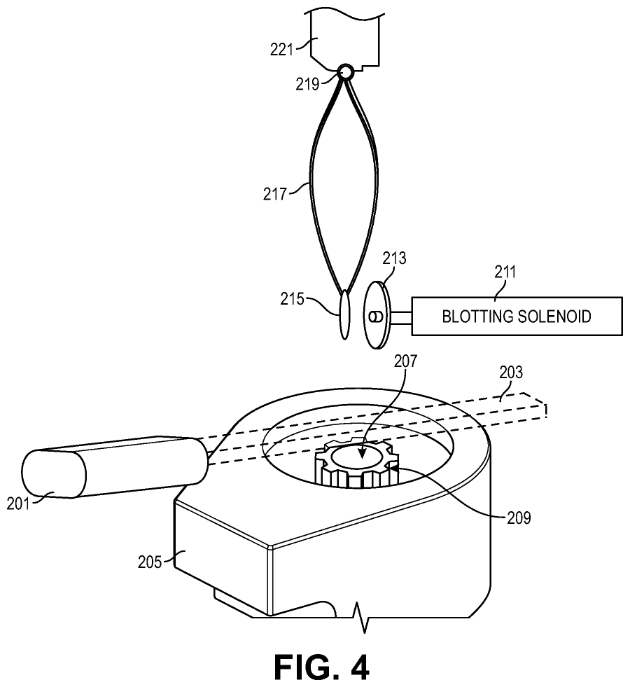

Referring now to FIG. 4, an embodiment of an exemplary system in accordance with the present disclosure is shown. The plunging solenoid 221 is energized by a power source (not shown) and controlled by a controller (not shown) to move the cryogrid 215 through the light beam 223 into the vitrification substance 207. In an aspect, the cryogrid 215 is operably coupled with the plunging solenoid 221 by an adapter 219 and a clamping means 217. Other means of moving the cryogrid 215 into the vitrification substance 207 (referred to herein as a cryogen) and coupling the cryogrid 215 with the plunging solenoid 221 are contemplated by the present disclosure. Before the specimen on the cryogrid 215 is vitrified, the blotting device 213 removes excess specimen from the cryogrid 215. The blotting solenoid 211, powered by a power source (not shown) and under the control of a controller (not shown), causes the blotting device 213 to remove the excess specimen. The amount of excess specimen that is removed is, for example, but not limited to, user-specified, a default amount based on, for example, but not limited to, the type of specimen, or a dynamic amount based on parameters associated with the system configuration. Before the cryogrid 215 enters the vitrification substance 207, it passes through the light beam 203 that is generated by the light source 201. The light source 201 is energized by a power supply (not shown) and controlled by a controller (not shown). In some configurations, the vitrification substance 207 is surrounded by a thermal regulation substance 209 for maintaining the temperature of the vitrification substance 207. In an aspect, the vitrification substance is ethane and the thermal regulation substance is nitrogen. Other substances are contemplated by the present disclosure. The vitrification substance 207 and thermal regulation substance 209 are staged in the cryogen container 205. The size and shape of the cryogen container 205 can vary depending upon the application.

Continuing to refer to FIG. 2, the time between when the cryogrid 215 begins its path towards the vitrification substance 207 and when it reaches the vitrification substance 207 is a configuration-dependent amount. A desired temporal resolution for a vitrified sample is an application-dependent amount. To achieve a desired temporal resolution, the light source 201 is activated at a time that is based on the configuration-dependent amount, the activation time of the plunging solenoid 221 and the application-dependent amount. In an aspect, the relationship among the variables is linear. Specifically, in an aspect, if the configuration-dependent amount of time (the time from when the plunging solenoid 221 is energized to when the cryogrid 215 reaches the cryogen) is 40 ms, and the application-dependent amount (i.e. the desired temporal resolution) is 1 ms, the light source 201 is energized 39 ms from when the plunging solenoid 221 is energized, or the absolute value difference between the configuration-dependent amount and the application-dependent amount. In another example, if the configuration-dependent amount is 60 ms and the application-dependent amount is 100 ms, the light source 201 is energized 40 ms from when the plunging solenoid 221 is energized.

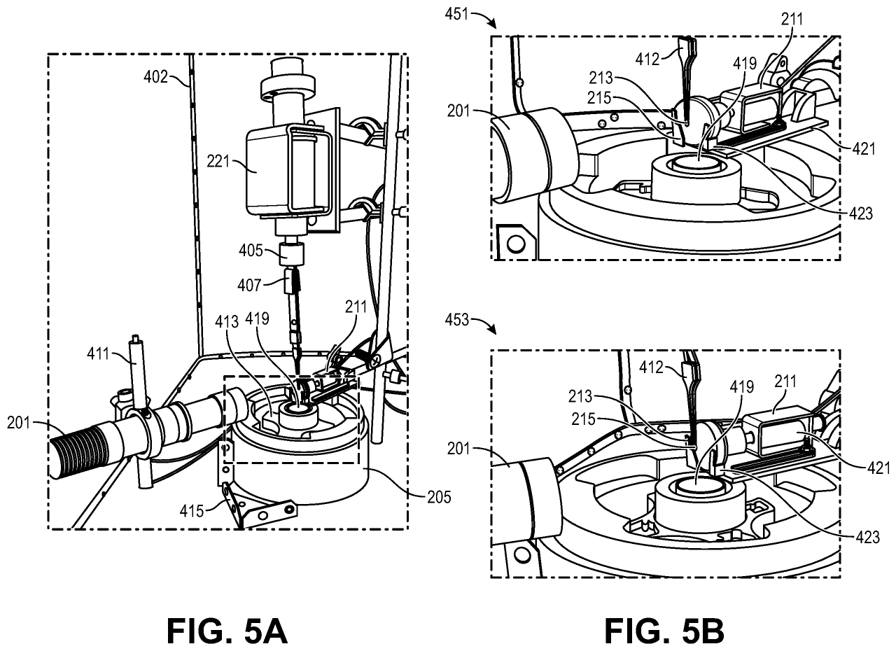

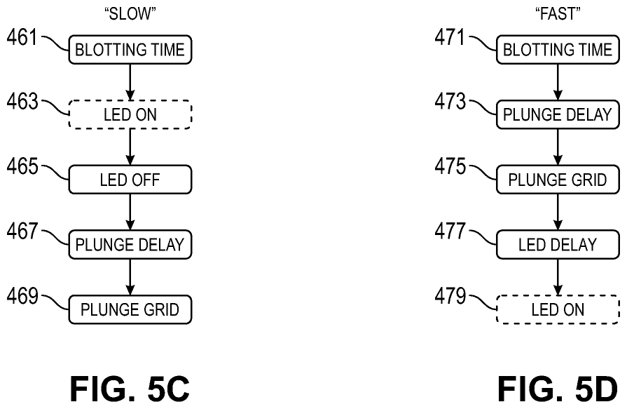

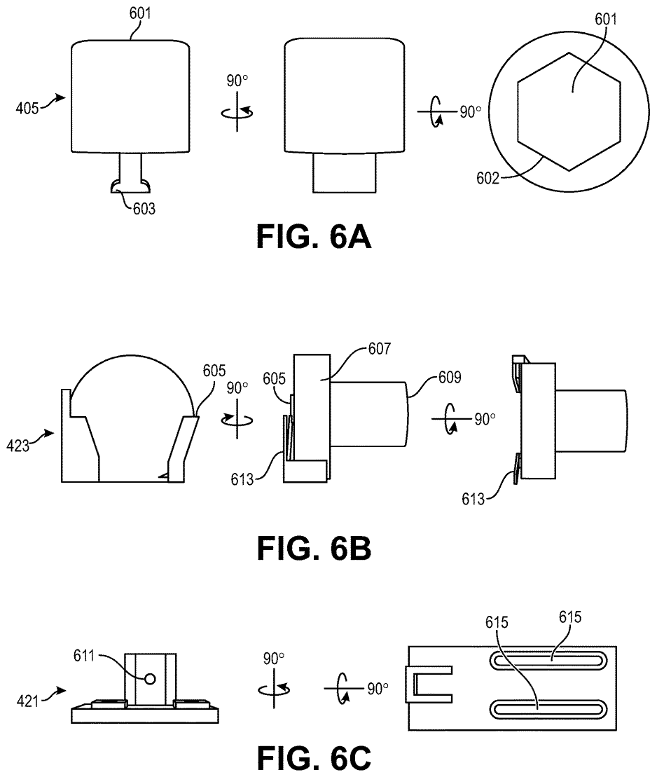

Referring now to FIG. 5A, shown is the overall construction of a system in accordance with embodiments of the present disclosure. Included are light strips 402 as a light source to illuminate samples at a wavelength that does not activate the system, a plunging solenoid 221, a tweezer attachment 405, a tweezers support post 407, a blotting solenoid 409, a brass cup (cryogen) 419, a grid box holder 413, a dewar 205, positioning brackets 417, and a light source 201. In FIG. 5B, shown are two operations available in a system in accordance with embodiments of the present disclosure: ‘slow’ 451 and ‘fast’ 453. The slow operation 451 involves the light source 201 at a pre-selected top position corresponding to the slow operation, illuminating the cryogrid 216 at a pre-selected starting position corresponding to a position where the cryogrid is located when the plunging solenoid is deactivated, equivalent to the top position of the LED. The fast operation 453 involves the light source 201 at a bottom position, illuminating the cryogrid 216 directly above the brass ethane cup 419. Blot support 421 and blot adapter 423 are also shown. In FIG. 6A, a device that holds a specific model of tweezers is shown. In FIG. 6B, a device for holding the filter paper in place while also having efficient blotting is shown. In FIG. 6C, a support mount that is designed specifically for the model of the solenoid used is shown. Other configurations and designs are possible.

In FIG. 5C, the steps for a slow operation 451 include, but are not limited to including, waiting 461 an amount of time for blotting to complete, turning on 463 the light source, turning off 465 the light source, waiting 467 an amount of time before plunging, and plunging 469 the cryogrid into the cryogen. As shown in FIG. 5D, the steps for a fast operation 453 include, but are not limited to including, waiting 471 an amount of time for blotting to complete, waiting 473 an amount of time before plunging, plunging 475 the cryogrid into the cryogen, waiting 477 an amount of time before turning on the light source, and turning on 479 the light source. See FIGS. 2A and 2B for further details.

Referring now to FIGS. 6A-6C, exemplary mount devices are shown. In FIG. 6A, schematic diagrams showing various views of the tweezer mount 405 are shown. The plunging solenoid attachment point 601 provides an interface point between the tweezer mount 405 and the plunging solenoid 221 (FIG. 5A). The tweezer attachment point 603 provides an interface point between the tweezer mount 405 and the tweezers 412 (FIG. 5B). In some configurations, the plunging solenoid 221 (FIG. 5A) includes a hex nut that is positioned in the hex nut cavity 602 to couple the plunging solenoid 221 (FIG. 5A) with the tweezer mount 405.

In FIG. 6B, schematic diagrams showing various views of the blotter mount (adapter), showing the placement points for filter paper 414 (FIG. 5B) and the solenoid attachment, is shown. The blotter mount 423 includes a holder 605 for the filter paper 414 (FIG. 5B), a back support 607 for the filter paper 414 (FIG. 5B), an attachment point 609 for the blotting solenoid 418 (FIG. 5B), and a slit 613 for the filter paper 414 (FIG. 5B).

In FIG. 6C, schematic diagrams showing various views of the support mount 421 for the blotting solenoid 418 (FIG. 5B) is shown. The support mount 421 includes an attachment point 611 for the blotter support 421 (FIG. 5B), and mount points 615 for the blotting solenoid 418 (FIG. 5B).

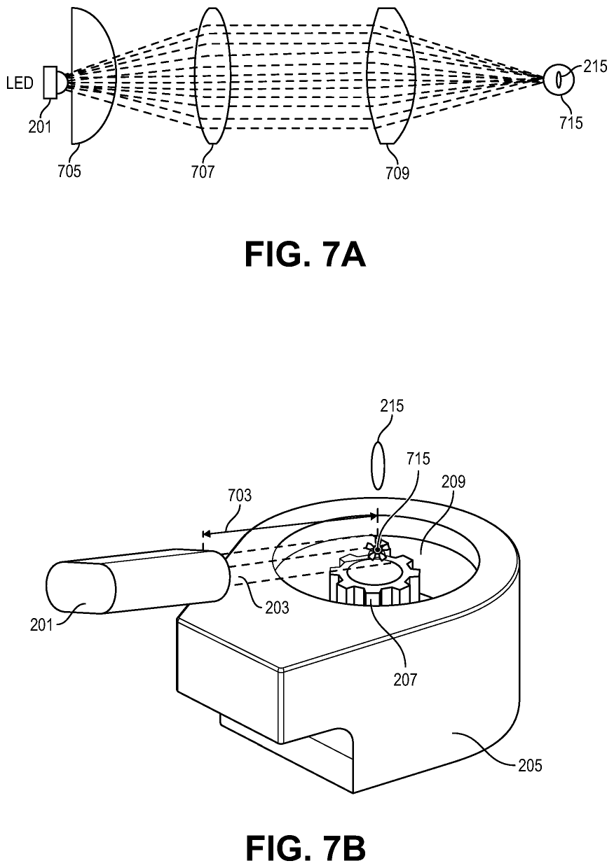

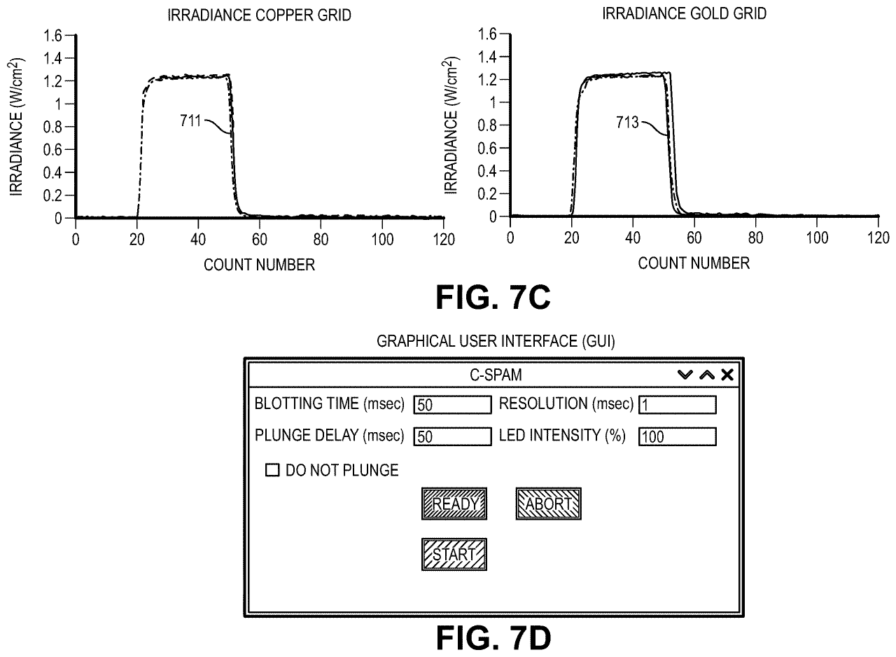

Referring now to FIGS. 7A-7D, light source lens design, irradiance graphs, and an exemplary user interface are shown. In FIG. 7A, a diagram of a three-lens design is shown. If the activating agent (light source) 201 is an LED that produces a light beam 203 that is not collimated, a parallel beam is formed and then focused to concentrate the beam at a focal point 715 where the cryogrid 215 is plunging through the beam 203. In an aspect, the light beam 203 is collimated and focused to the focal point 715 by one or more lenses. In an aspect, two lenses are used to collimate the beam, and one is used to focus the beam on the focal point 715. In an aspect, the two lenses that collimate the beam are an aspheric condenser lens 705 and a bi-convex lens 707. In an aspect, the focusing lens is an achromatic doublet 709. Any number and types of lenses can be used to achieve the focal point 715 within the restrictions of the configuration and application. With respect to an exemplary configuration, the activating agent 201 is positioned at a height above the thermal regulation substance 209 such that the lens or combination of lenses is not affected by the thermal regulation substance 209. In an aspect, the activating agent 201 is positioned at a pre-selected distance from the desired focal point 715. In an aspect, the activating agent 201 and the desired focal point 715 are separated by the size of radius 703 of the cryogen container (dewar) 205. If the light source irradiance is too weak to uncage the caged ligands, the focal point 715 of the activating agent (e.g. an LED) 201 can be adjusted to adjust the output, specifically to increase the power. In FIG. 7C, the irradiance (W cm⁻²) 711 of the light source 201 at 100% with a copper grid present show a maximum of 1.3 W cm⁻², while the irradiance (W cm⁻²) 713 of the light source 201 at 100% with the gold grid present shows the same maximum. In FIG. 7D, an exemplary user interface displaying tunable parameters is shown.

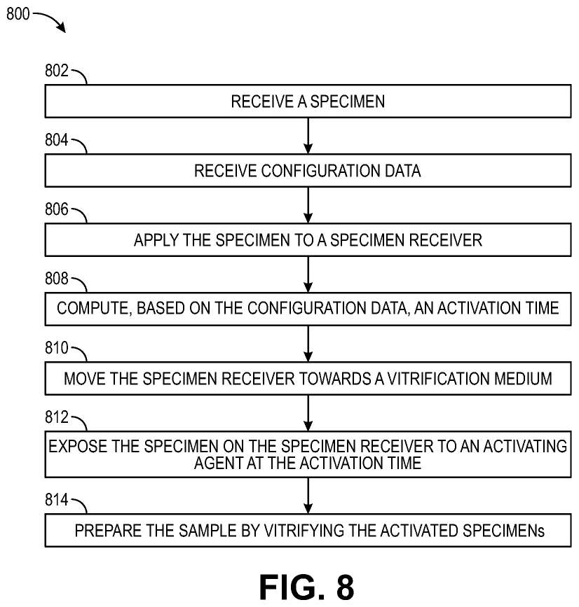

Referring now to FIG. 8, an exemplary method 800 for preparing a sample, in accordance with embodiments of the present disclosure, includes, but is not limited to including, the step of receiving 802 a specimen, and applying the specimen to a cryogrid. The method 800 includes receiving 804 configuration data, and applying 806 the specimen to a specimen receiver. The method 800 includes computing, based on the configuration data, an activation time, and moving 810 the specimen receiver towards a vitrification medium. The method 800 includes exposing 812 the specimen on the specimen receiver to an activating agent at the activation time, and preparing 814 the sample by vitrifying the specimen.

The activation time optionally includes a difference between the application-dependent desired temporal resolution and the configuration-dependent time difference. The method 800 can optionally include incubating the specimen with a ligand, and the ligand can optionally include an inactive, chemically caged ligand. The method 800 can optionally include focusing the activating agent to a focal point in a path of the specimen receiver.

Certain embodiments can be performed using a computer program or set of programs executed by an electronic processor. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

While the disclosure includes descriptions that refer to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A method for preparing a sample for time-resolved cryo-electron microscopy comprising:
receiving a specimen;
receiving configuration data;
applying the specimen to a specimen receiver;
computing, based on the configuration data, an activation time;
moving the specimen receiver towards a vitrification medium;
exposing the specimen on the specimen receiver to an activating agent at the activation time; and
preparing the sample by vitrifying the activated specimen.

2. The method as in claim 1 further comprising:
removing excess of the specimen from the specimen receiver.

3. The method as in claim 1 wherein the configuration data comprises:
an application-dependent desired temporal resolution and a configuration-dependent time difference between when the specimen receiver begins moving towards the vitrification medium and when the specimen enters the vitrification medium.

4. The method as in claim 3 wherein the activation time comprises:
a difference between the application-dependent desired temporal resolution and the configuration-dependent time difference.

5. The method as in claim 1 further comprising:
incubating the specimen with a ligand.

6. The method as in claim 5 wherein the ligand comprises:
an inactive, chemically caged ligand.

7. The method as in claim 1 further comprising:
focusing the activating agent to a focal point in a path of the specimen receiver.

8. A system for preparing a sample for cryo-electron microscopy comprising:
a specimen delivery device configured to access a specimen and apply the specimen to a specimen receiver, the system configured to generate a first signal when the specimen is applied to the specimen receiver;
a plunging device configured to move the specimen receiver into a cryogen, the plunging device configured to generate a second signal when the specimen is moved;
an activation device configured to activate the specimen, the activation device configured to release an activating agent after a time delay, the specimen being activated by the activating agent;
a vitrification device configured to receive the specimen receiver and vitrify the activated specimen in a vitrification medium; and
a controller configured to execute instructions including:
accessing configuration data including a desired temporal resolution, and a configuration-dependent time difference between when the specimen receiver begins moving towards the vitrification medium and when the specimen enters the vitrification medium;
computing the time delay based at least upon the desired temporal resolution and the configuration-dependent time difference;
receiving the first signal;
activating the plunging device based on the first signal;
receiving the second signal when the plunging device is activated;
activating the activation device based at least on the time delay and the second signal; and
deactivating the plunging device based at least on the second signal.

9. The system as in claim 8 wherein the specimen delivery device comprises:
a cryogrid.

10. The system as in claim 8 wherein the activating agent comprises:
an electromagnetic signal.

11. The system as in claim 8 wherein the activating agent comprises:
an optical signal.

12. The system as in claim 8 wherein the activating agent comprises:
a thermal sensation.

13. The system as in claim 8 further comprising:
a specimen incubator configured to incubate the specimen with a ligand.

14. The system as in claim 13 wherein the ligand comprises:
an inactive, chemically caged ligand.

15. The system as in claim 8 further comprising:
a blotter device configured to remove excess of the specimen from the specimen receiver.

16. The system as in claim 15 wherein the blotter device comprises:
a blotter;
a solenoid configured to activate and deactivate the blotter; and
a communications port configured to send a third signal to the controller when the blotter is deactivated.

17. The system as in claim 8 wherein the plunging device comprises:
a plunger;
a solenoid configured to activate the plunger;
a communications port configured to send the second signal to the controller when the plunging device is activated; and
a coupler configured to couple the plunging device with the specimen receiver.

18. The system as in claim 8 further comprising:
a sensor configured to collect information about the system.

19. The system as in claim 8 wherein the instructions comprise:
focusing the activating agent to a focal point in a path of the specimen receiver.

20. The system as in claim 8 wherein the specimen receiver comprises:
a cryogrid.
